(19) United States
(12) Patent Application Publication
(10) Pub. No.: US 2023/0277394 A1
(43) Pub. Date: Sep. 7, 2023

(54) Reclining Chair with Multi-Axis Programmed Therapeutic Motion

(71) Applicant: Steven Utter, Chandler, AZ (US)

(72) Inventor: Steven Utter, Chandler, AZ (US)

(21) Appl. No.: 18/116,784

(22) Filed: Mar. 2, 2023

Related U.S. Application Data
(60) Provisional application No. 63/316,252, filed on Mar. 3, 2022.

(51) Int. Cl. A61G 5/14; A61G 5/10; A61G 5/12

(52) U.S. Cl. CPC A61G 5/14; A61G 5/1059; A61G 5/1067; A61G 5/125; A61G 2203/10; A61G 2203/70

(57) ABSTRACT

The disclosed invention is a multi-motion chair with motorized movement that provides continuous therapeutic movement. The therapeutic chair utilizes multiple pivoting points for the back, seat, legs, and arms. Pivoting motors and linear actuators are installed at rotatable points of the chair and provide multiple ways of activating therapeutic motion. The therapeutic motion is directed by a programmable controller which can move the chair in a continuous motion automatically without additional input from the user and therefore helps to reduce joint and muscle stress or pain while seated for long periods of time.

### CROSS REFERENCE TO RELATED APPLICATIONS

This application claims the benefit of U.S. Provisional application number 63/316,252 filed on Mar. 3, 2022. This referenced provisional application is incorporated by reference herein.

### STATEMENT OF GOVERNMENT INTEREST

Not applicable.

### BACKGROUND OF THE INVENTION

### (1) Field of the Invention

This invention is directed to chairs and reclining chairs with automated moving features to provide continuous therapeutic movement according to programmed and automated therapeutic motions.

(2) Description of Related Art

JP 6478972B2 patent discloses a manually positioned ergonomic workstation having a variety of adjustable positions for a chair, monitor, input device support, and work tray. AU 2018101092A4 discloses a manually positioned movable chair on casters. Similarly, AU772235B2 discloses a five caster office chair with manual adjustments.

U.S. Pat. No. 5,542,746 discloses a mobile chair with adjustable positioning features. U.S. Pat. No. 5,630,648 discloses a fixed chair with an adjustable back to seat position for the user leaning forward and rearward. U.S. Pat. No. 9,801,472 entitled discloses a manually adjustable sitting chair on a large base with casters. U.S. Pat. No. 6,923,503 discloses a mobile chair with manual adjustment features. U.S. Pat No. 7,887,130 discloses a single axis motion for a backrest, display, and keyboard for someone who is sitting and then tilts backward.

Lift chairs, or riser armchairs, are chairs that feature a powered lifting mechanism that pushes the entire chair up from its base and so assists the user to a standing position. Such devices are currently commercially available for sale. Typically, a single motor is used to activate chair motion to a standing or a reclining position, with a variety of mechanical linkages. U.S. Pat. No. 8,398,171 is an example.

Typically, a lift chair has sequential motion. When reclining from a sitting position, the leg rest lifts, and when at the highest point, the chair leans back. The user activates the motion with a button pad. When lifting to a standing position, the chair lifts and tilts simultaneously due to the mechanical linkage. The simplification of motion by linkages is not suitable to a variety of therapeutic motion required by the joints and muscles of individuals, as this kind of chair is very limited.

In the therapeutic industry, “Motion is lotion” is a commonly used phrase by both physical therapists and osteo arthritis doctors.

Non-painful, low intensity, and low impact movement is a key ingredient to help joints recover, to prevent joint pain, and improve the range of motion. When joints are not moving, they get stiff. When joints move, the body produces more synovial fluid, and that fluid is recruited into the joint. It is the lubrication inside a joint. It also supplies oxygen and nutrients and removes carbon dioxide and metabolic wastes from the chondrocytes in the surrounding cartilage.

It is desirable to provide a convenient method for low impact, low intensity movement that helps promote synovial fluid moving into the joint.

Though chairs with pivoting points for various body parts and propulsion means for movement of the chair is disclosed by the referenced patents, they do not mention continuous movement as a therapeutic method. Current art moving chairs require continuous input from the user. Most people sitting in chairs are preoccupied with watching tv or working at a computer. Consequently, the user forgets to change position.

There is a need in the art for continuous therapeutic movement in a preprogrammed manner which does not require the continual input from the user. Therefore, a user is not distracted from whatever activity they may be involved with, such as watching tv or working.

Even though prior art mentions chairs with pivoting points for various body parts and propulsion means for therapeutic movement of the chair, they do not disclose continuous movement as a therapeutic method. They are largely restricted to sedentary position adjustments. Prior art chairs are unsuitable for therapeutic motion as it will require continuous or intermittent input from the user. Since most people sitting in chairs are usually occupied with watching TV or working at a computer, the user forgets to change position.

### SUMMARY OF THE INVENTION

The disclosed invention provides a chair with multiple pivoting points for the back, seat, legs, and arms. Pivoting motors and linear actuators are installed at rotatable or translational parts of the chair and provide multiple ways of activating therapeutic motion. The motion is directed by a programmable controller which provides motion to assist patients and users that need to recover from acute medical conditions, or to receive gentle motion for persistent conditions, or to relieve stress while working by changing positions automatically.

### BRIEF DESCRIPTION OF THE FIGURES

FIG. 1 shows an embodied chair with a controller and multiple rotational axis.

FIG. 2 shows a side view of FIG. 1.

FIG. 3 shows an example motor arrangement that provides two axis of movement for an arm or leg support.

FIG. 4 shows multiple degrees of rotation in the chair.

FIG. 5 shows how the chair will aid in standing.

FIG. 6 shows an operator pushbutton interface to a controller.

FIGS. 7A-7B show how an included workstation support is rotatable.

FIG. 8 shows a containment cushion and safety straps for a patient that is relatively immobile.

FIGS. 9A-9D show exemplary therapeutic motion for a patient as ordered for a particular need.

FIGS. 10A-10B show the complex motion needed to bring a sitting patient with leg support to an upright position.

### DETAILED DESCRIPTION OF THE INVENTION

The embodied invention is a multi-motion chair with motorized movement that provides continuous movement. That is, there is a range of motion that provides arm, length, torso movements according to a pre-programmed motion.

The embodied chair provides continuous and slow movement in a pre-programmed manner which does not require the continual input from the user. Therefore, a user is not distracted from whatever activity they may be involved with, such as watching tv or working.

A comparison survey of patients having joint pain were treated by restful static sitting for an hour, and then by continuous therapeutic motion for an hour. After restful treatment, the patients stood up and judged whether their pain and mobility was better, and by how much. Static rest did little to reduce their pain.

The patients were then treated to therapeutic motion that provided 0-90 degree knee bending motion at a cycle rate of 120 times per hour. Simultaneously, the hips were bent from 0-10 degrees at the same cycle rate. The patients then stood up and again asked to judge their pain and mobility levels. The patients reported improvement in the range of 20-50%. Such improvements are encouraging and point to the need for therapeutic treatments that entice the body to recover.

Another benefit of the chair is the relief from stress and tension. Sitting in a single position for long periods of time causes muscular tension and even misalignment of the skeletal structure. Moving in a slow and continuous manner and over a wide range of motion helps to relieve stress, increase joint function and relieve stress points on the same part of the body distributing weight mass over a variety of body points.

Another benefit of the chair is conveniently lowering joint pain and improving the range of motion while:
1. Watching TV, looking at a phone or tablet, or reading.
2. Relaxing.
3. Recovery from injuries.
4. Working at a computer or workstation.

The embodied chair is a skeleton support for a person in a way that supports mobility, flexibility and potentially reduces joint and muscle pain. This is done by moving the person through a slow and continuous movement while seated or standing in the “chair”. Brief pauses are optionally included to provide periods of rest for joint motion.

The chair has any number of motors or linear actuators that provide continuous movement in a subtle manner so that it is minimally distractive to the user while seated. This allows the individual to work on a computer or watch television. However, the programmed motion keeps the user moving to help reduce the onset of joint pain, muscle pain, or cramping.

The chair controller has preset buttons that allow the user to select a variety of movements. Examples are:
1. Lower leg lifts extending the legs bending them at the knees and raising them as in a standard ordinary reclining chair.
2. Raising the user vertically to a near vertical posture, or partially vertical.
3. Reclining the back support to a horizontal position, or any varying degree of that movement.
4. Advanced motion may include arm movement using arm rests to lift the arm up and down in a slow, continuous motion. Additional movements include elbow joint movements.
5. A standard automated movement prescribed by a medical practitioner residing in memory. Also, a repeat of a prior automated movement in memory.
6. Any movement may be linear, circular, or elliptical.

On some models only 2-3 preset buttons are used, and other models will use a dozen buttons to control varying degrees of movement. Optionally, there are individual leg controls which allow legs to move independently in two different directions.

An optional workstation support is included in the design by using an additional pivoting motor so that the workstation table remains in the same relative position to the user, even though the user is in constant motion. Typically, this means that the angle of the table remains at the same relative angle to the back rest, or remains horizontal.

The creation of automated, predetermined, and continuous movement will aid in reducing joint pain and improve the range of motion. Therefore, using a series of preset buttons that effect a continuous and slow motion will provide a minimally distracting environment for the user.

The items shown in the figures are:
101 Headrest
102 Backrest
103a,b Armrests
104 Backrest motor
105 Backrest rotation axis
106 Base with wheels
107a,b Rotating leg rests
108a,b Rotating leg motors
109 Leg rest rotating axis
110 Arm rest motor
111 Arm rest rotating axis
112 Headrest tilting direction
113 Controller interface
114 Seat
201a,b Lifting rods
301 Vertical motor
302 Vertical motor mounting bracket
303 Vertical motor shaft
304 90 degree connector tube
305 Horizontal motor shaft
306, 307 Tightening nuts
308 Horizontal pivot motor
309 Seat attaching bracket
310 Motor attaching bolts
311 Seat attaching bolts
312 Horizontal pivoting motor rotational axis
313 Vertical motor rotational axis
601-608 Pushbuttons
611 Indicator lights
701 Pivotable workstation support
702 Workstation support pivoting motor
801 abdominal cushion
802 connecting arm
803a,b,c safety straps
901 A complete motion cycle
902 Period of rest
903a,b Rate of Movement
911 Another complete motion cycle
912 Period of rest
913a,b Another Rate of Movement
1001 Tray

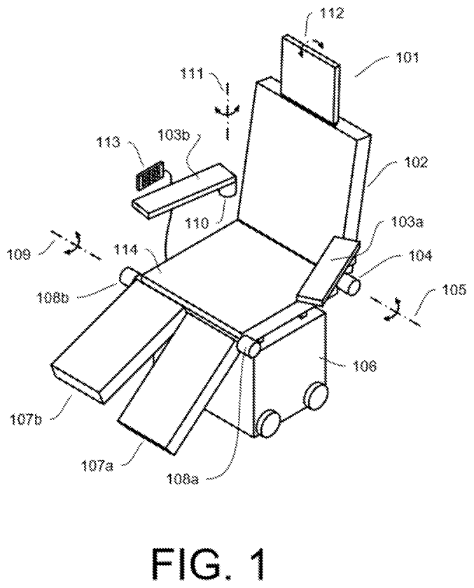

FIG. 1 shows an embodied chair with a controller 113 and multiple rotational axis 105, 109, 111, 112. The chair includes a headrest 101, a backrest 102, a seat 114, and two leg rests 107a,b. A rotating motor 104 is used to vary the angle between the seat and backrest. two motors 108a,b vary the angle between each leg rest and the seat. Two motors (only one shown 110) pivot the arm rests 103a,b. A base 106 with wheels moves the chair. The wheels are optional as some therapies will take place in a treatment facility, and chair mobility is not needed.

The base includes a programmable controller (not shown), and an optional battery. Power is optionally provided by plugging into an electrical outlet. The illustrated headrest is manually adjustable 112 and is optionally automatically adjustable. A controller interface 113 is connected to the programmable controller which is used to operate the chair. The controller interface is further discussed in FIG. 6.

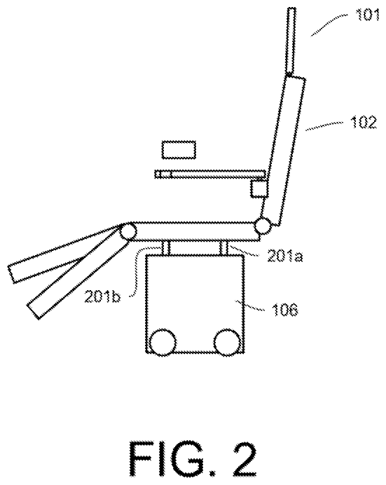

FIG. 2 shows a side view of the embodied chair of FIG. 1. The two lifting rods 201a,b provide the ability to lift the seat and change the angle of the seat by varying the amount of lift from each rod. The rods are optionally part of a linear actuator contained within the base 106 and powered by an electrical motor. The actuator optionally includes sensors that report the rod extension length to the controller. This allows the operator to conveniently select the desired angle for the seat, and the controller determines the amount of extension by each rod.

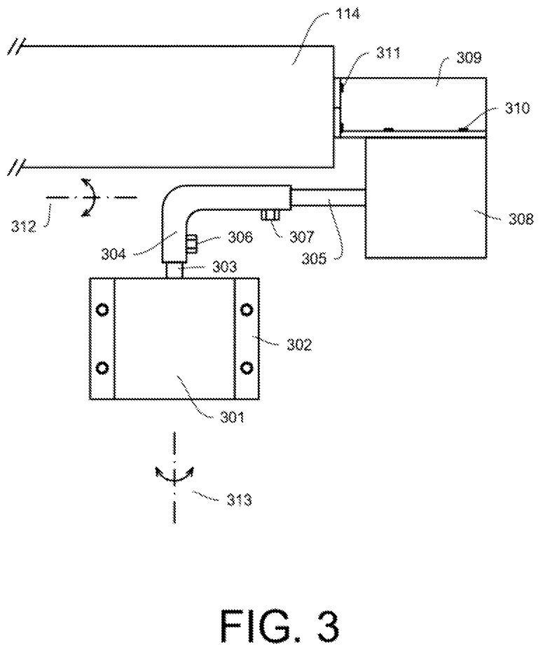

FIG. 3 shows an example motor arrangement that provides two axis movement for an arm or leg support. A vertical motor 301 and a mounting bracket 302 are attached to the base (not shown). The vertical motor shaft 303 is attached to a 90 degree connector tube 304, which is connected to the horizontal motor shaft 305. Two bolts 306,307 secure the motor shafts to the connector tube. The horizontal motor 308 is connected to a bracket 309 which is connected to the seat 114. Securing bolts 310 and 311 connect the motor to the bracket, and the bracket to the seat.

The arrangement of the two motors and the connection between them provide rotational motion for the seat in two directions 312 and 313 as illustrated. This provides two separate motions for the user.

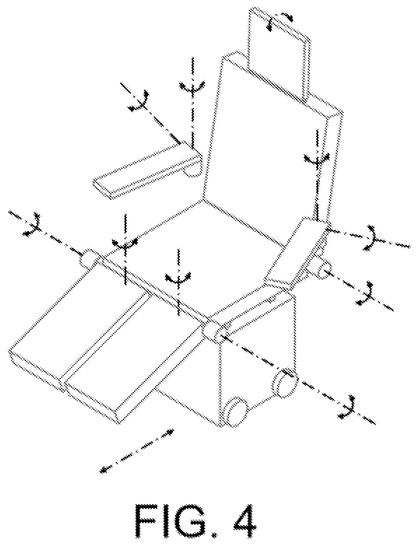

FIG. 4 shows multiple degrees of rotation and translation of the chair. In this case, the chair has 10 degrees of freedom as illustrated. By using a joystick (not shown) for controlling the base wheels, an additional turning degree of freedom is added.

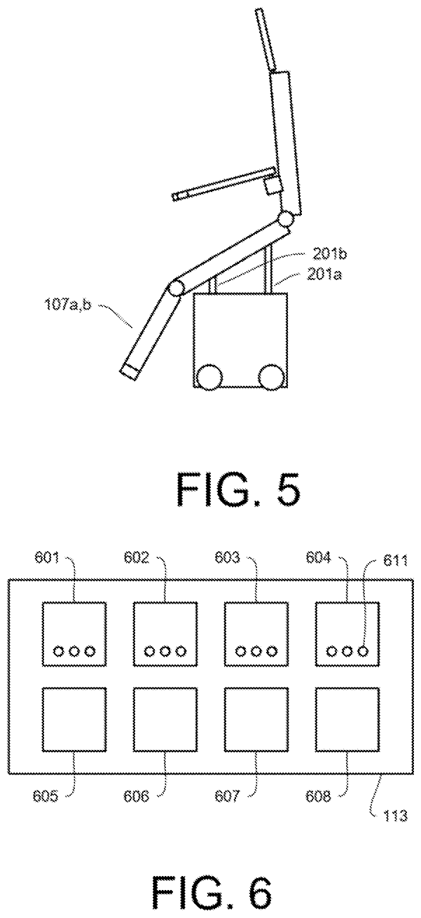

FIG. 5 shows how the chair provides standing up assistance to the user. The two motorized linear actuators 201a,b are used to tilt the chair seat to provide standing assistance, or therapeutic motion in combination with standing.

FIG. 6 shows a simplified controller interface 112 with pushbutton 601-608 functions. The buttons are connected to a programmable controller to provide any of the following therapeutic functions:
1. Independent two axis arm position motion, or in combination with other motions.
2. Independent two axis leg position motion, or in combination with other motions.
3. Independent seat position motion, or in combination with other motions.
4. Independent backrest position motion.
5. Optional automatic headrest adjustments.
6. Power on/off functions as well as motion on/off functions.
7. Pushbutton multiple pressing where a particular motion cycles through options, such as slow, fast, and faster as indicated by indicator lights 611.
8. Manual or Automatic workstation support in combination with the backrest position.
9. A therapeutic stop button which allows the patient to stop the therapeutic cycle and quickly return the chair to a sitting or standing position.

In a preferred embodiment, a pushbutton provides a continuous movement cycle, and when the cycle ends, the cycle automatically repeats until the user deselects the button.

In another preferred embodiment, the pushbuttons provide reduced or wider ranges of motion for the user to select.

In another preferred embodiment, the pushbutton interface is located in a smart phone application program (app). The smartphone then communicates with the programmable controller through a wireless connection, such as Bluetooth or a local router.

Therapeutic motion is as described as a continuous or semi-continuous pre-programmed motion of some or all of the moving portions of the chair so that it moves slow enough so as not to be distracting with at least one cycle of movement every 5 minutes and no more than 4 cycles per minute. Such motion may be:
1. Simple cycles of motion at a fixed amount with periods of rest. They cycle then repeats itself at predetermined intervals.
2. Combination of motion to allow multiple movements to allow simultaneously or in sequence.
3. Combination of motion needed to raise the individual being treated to a standing or reclining posture.
4. Combination of motion that allows an individual to continue work at a workstation.

The programmable controller is preferably at least one microcontroller that is mounted on a printed circuit board that is connected to an operator interface, inputs, and outputs. The controller is programmed by an operating language to process a mixed analog and digital architecture. By processing inputs and control commands from the operator interface, it sends outputs to various electrical equipment for controlling motion. The programmable controller includes both volatile and non-volatile memory and needed computational and processing speed to accomplish the function of multiple programmable motions. The programmable interconnecting structure provides for communication of input/output data between all analog and digital circuits. The controller optionally connects with operator interfaces through wireless means, such a smartphone or handheld device. Preferably, the programmable controller resides in the base 106 and is connected to power supplied by a battery, or optionally a powered electrical cord.

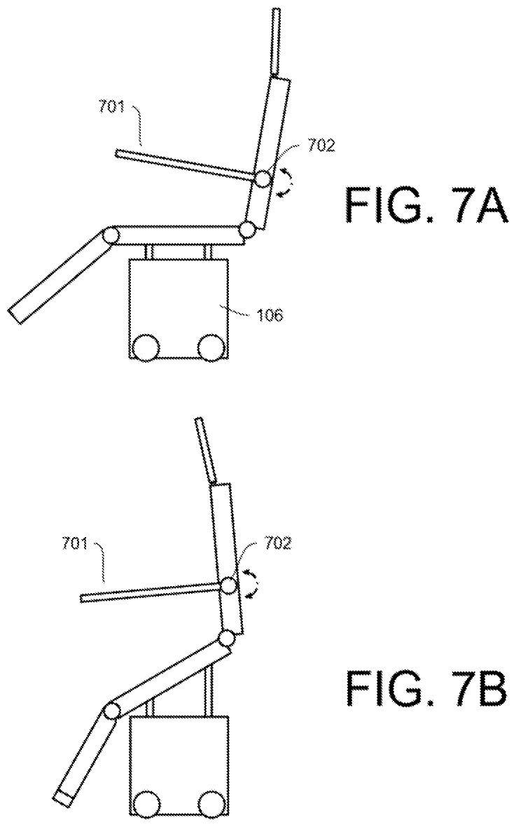

FIGS. 7A-7B show how a flat workstation support is rotatable. In this case, the support 701 automatically rotates 702 in combination with the backrest angle change, to keep the angle to the backrest the same, or optionally to keep it horizontal. This allows for convenient typing on a keyboard set on top of the workstation support. For clarity of illustration, the arm rests are not shown.

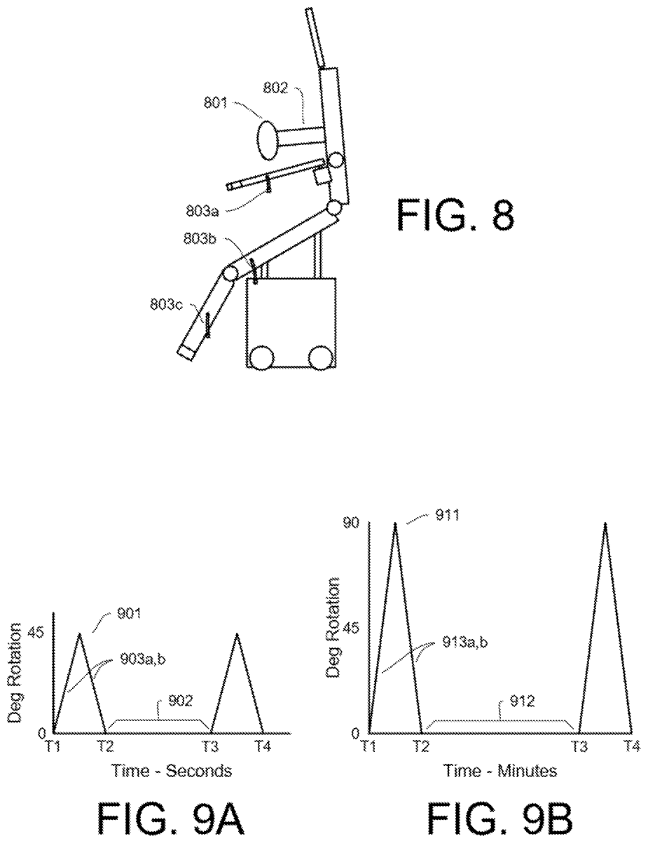

FIG. 8 shows a safety cushion and safety straps for a patient that is relatively immobile or may be drowsy or sleeping. An abdominal cushion 801 is attached to the backrest by at least one connecting arm 802. Safety straps 803a,b,c are used to prevent the patient from falling out of the chair. Alternately, a complete safety harness is connected to the chair to prevent falls or injury.

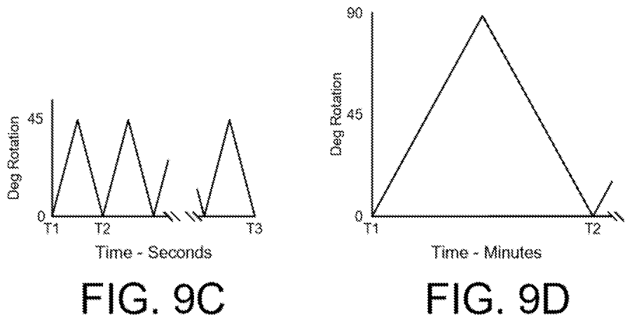

FIGS. 9A-9D show exemplary therapeutic motions for a patient as ordered by a medical practitioner for a particular need. A therapeutic movement rate is in the range of at least one complete cycle every 5 minutes and is no faster than 4 complete cycles in a single minute.

In FIG. 9A, a chart showing the rotation amount of 45 degrees for complete motion cycle 901 between times T1 and T2 with a period of rest 902 between times T2 and T3. The second cycle time between T3 and T4 is usually the same as the first cycle but is optionally longer or shorter. The rate of movement 903a,b is typically the same in both directions and the rate varies depending on the medical need.

FIG. 9B shows a rotation amount of 90 degrees for a motion cycle 911 between times T1 and T2 with a period of rest 912 between time T2 and T3. The rotation is higher at 90 degrees. Again, the second cycle time between T3 and T4 is usually the same as the first but could be longer or shorter. The rate of movement 913a,b is different than FIG. 9A. As illustrated the repeat cycles can be in seconds or in minutes.

FIG. 9C shows a rotation for a patient for a time between T1 and T2 and repeats until T3, when the cycle preferably returns the patient to the original position. FIG. 9D shows a long cycle from times T1 to T2 with a larger rotation. Such therapies are designed to allow motion so slowly that it is not disturbing, and the patient can complete other tasks such as typing on a keyboard.

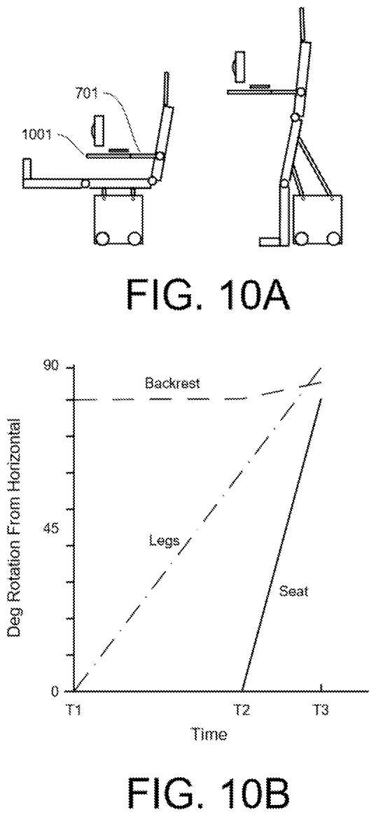

FIGS. 10A-10B show the complex motion needed to bring a sitting patient with leg support to an upright position. The motion also includes a support tray 1001 attached to the chair arms. In this therapeutic case the leg motion starts at time T1. When the leg motion has made sufficient progress to keep the patient stable, at T2 the seat and backrest begin to move. At T3, the cycle needed to bring the patient to standing is complete. The standing therapeutic cycle then completes by moving in reverse order and direction. Periods of rest are optionally included between cycles.

The small amount of rotation needed to keep the computer and keyboard horizontal is not shown in FIG. 10B for readability. However, the pivot point for the supporting arm will rotate about 4 degrees, as illustrated in FIG. 10A, and that motion would start at time T2.

The complex move is based on the need for the patient to feel comfortable and safe with the chair movement by making the legs move first.

FIGS. 10A-10B is only exemplary motion, and the general concept of timing different motion is shown by differences in the rate of movement and when motion starts.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

Amendments to the claims:

1. A motion controllable chair configured to provide multiple therapeutic motions comprising:
A) a base having at least one linear actuator that is connected to a chair seat,
B) said at least one linear actuator adapted to provide a tilting function to said chair seat,
C) said chair seat is pivotably connected to at least one leg rest by a first motor adapted to provide a rotating function,
D) said chair seat is pivotably connected to a backrest by a second motor adapted to provide a rotating function,
E) a programmable controller connected to a user interface,
F) said programmable controller connected to said first motor, said second motor, and said at least one linear actuator,
G) said programmable controller configured by programming to operate said at least one linear actuator, said first motor, and said second motor,
H) whereby said motion controllable chair and said programmable controller provides an automated therapeutic motion of a repeatable cycle,
I) said repeatable cycle has a length between once every 5 minutes and once every 15 seconds, and
J) whereby said automated therapeutic motion is free of additional user input after said repeatable cycle is activated.

2. The motion controllable chair according to claim 1, wherein said repeatable cycle includes periods of non-movement between sequential said repeatable cycles.

3. The motion controllable chair according to claim 1, wherein said base having multiple wheels for translational motion.

4. The motion controllable chair according to claim 1, wherein said user interface includes a therapeutic stop button, said therapeutic stop button configured to halt said automated therapeutic motion and quickly return said motion controllable chair to a sitting or standing position.

5. The motion controllable chair according to claim 1, wherein said automated therapeutic motion raises said motion controllable chair to a standing position, said automated therapeutic motion includes keeping a support tray horizontal or perpendicular to said backrest.

6. The motion controllable chair according to claim 1, wherein said backrest is connected to a headrest.

7. The motion controllable chair according to claim 1, wherein said backrest is connected to at least one armrest by a third motor adapted to provide a rotating function, said programmable controller configured by programming to operate said third motor, said at least one armrest incorporated into said automated therapeutic motion.

8. A method of providing multiple therapeutic motions with a motion controllable chair comprising:
A) providing:
a) a base having at least one linear actuator that is connected to a chair seat,
b) said at least one linear actuator adapted to provide a tilting function to said chair seat,
c) said chair seat is pivotably connected to at least one leg rest by a first motor adapted to provide a rotating function,
d) said chair seat is pivotably connected to a backrest by a second motor adapted to provide a rotating function,
e) a programmable controller connected to a user interface,
f) said programmable controller connected to said first motor, said second motor, and said at least one linear actuator,
g) said programmable controller configured by programming to operate said at least one linear actuator, said first motor, and said second motor,
h) whereby said motion controllable chair and said programmable controller provides an automated therapeutic motion of a repeatable cycle,
i) said repeatable cycle has a length between once every 5 minutes and once every 15 seconds, and
B) operating said programmable controller through a user interface to provide said automated therapeutic motion of said repeatable cycle,
C) whereby said automated therapeutic motion is free of additional user input after said repeatable cycle is activated.

9. The method according to claim 8, wherein said repeatable cycle includes periods of non-movement between sequential said repeatable cycles.

10. The motion controllable chair according to claim 8, wherein said base having multiple wheels for translational motion.

11. The method according to claim 8, wherein said user interface includes a therapeutic stop button, said therapeutic stop button configured to halt said automated therapeutic motion and quickly return said motion controllable chair to a sitting or standing position.

12. The method according to claim 8, wherein said automated therapeutic motion raises said motion controllable chair to a standing position, said automated therapeutic motion includes keeping a support tray horizontal or perpendicular to said backrest.

13. The method according to claim 8, wherein said backrest is connected to a headrest.

14. The method according to claim 8, wherein said backrest is connected to at least one armrest by a third motor adapted to provide a rotating function, said programmable controller configured by programming to operate said third motor, said at least one armrest incorporated into said automated therapeutic motion.
